(19) United States
(12) Patent Application Publication
(10) Pub. No.: US 2007/0119320 A1
(43) Pub. Date: May 31, 2007

(54) Printing blanket having improved dynamic thickness stability

(76) Inventors: Joseph L. Byers, Inman, SC (US); W. Toriran Flint, Asheville, NC (US); Samuel R. Shuman, Belgrade, MT (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/604,521

(22) Filed: Nov. 27, 2006

Related U.S. Application Data
(60) Provisional application No. 60/740,081, filed on Nov. 28, 2005.

(51) Int. Cl. B41F 13/10

(52) U.S. Cl. 101/375

(57) ABSTRACT

A printing blanket is provided which resists gauge loss throughout its useful life when subjected to printing nip pressures. The printing blanket includes a printing surface layer and at least one fabric ply. The fabric ply is treated by impregnation with a 100% solids elastomeric urethane compound which penetrates the air spaces of individual fiber bundles in the fabric ply and fixes the individual fibers in the ply from relative movement so that that the blanket is resistant to permanent deformation. The blanket including the treated fabric ply retains at least 95% of its original gauge throughout its useful life.

### CROSS REFERENCE TO RELATED APPLICATIONS

This application claims the benefit of U.S. Provisional Application No. 60/740,081 entitled PRINTING BLANKET HAVING IMPROVED DYNAMIC THICKNESS STABILITY filed Nov. 28, 2005. The entire contents of said application are hereby incorporated by reference.

### BACKGROUND OF THE INVENTION

The present invention relates to a printing blanket, and more particularly, to a printing blanket having an improved dynamic thickness stability and resistance to gauge loss.

One of the most common commercial printing processes is offset lithography. In this printing process, ink is offset from a printing plate to a rubber-surfaced printing blanket mounted on a blanket cylinder before being transferred to a substrate, such as paper. Typically, the printing blanket is reinforced with a number of fabric and/or polymer plies.

During the step in which the inked image is transferred from the plate to the blanket and the step where the image is transferred from the printing blanket to paper, it is important to have intimate contact between the two contacting surfaces. This is ordinarily achieved by positioning the blanket-covered cylinder and the supporting cylinder it contacts so that there is a fixed interference between the two and so that the blanket is compressed throughout the run to a fixed depth.

However, printing blankets currently used in the art tend to lose thickness (i.e., gauge) when they are initially tensioned and installed, and further lose thickness as the blanket is repeatedly exposed to the interference pressures at the nips between the respective printing cylinder, blanket-covered cylinder and supporting cylinder. Blankets can fail from a permanent deformation in a portion of the entire blanket surface, or from a gradual deterioration of blanket gauge over time due to the repeated cycling of interference pressures on the blanket's surface.

Attempts have been made to provide printing blankets which resist gauge loss over time. For example, commonly assigned U.S. Pat. No. 5,498,470 teaches a printing blanket including a fabric ply which has been impregnated with an elastomeric compound to resist gauge loss. However, the process requires the use of solvents to dissolve the elastomeric compound to liquefy the elastomer prior to impregnation. Such solvents must then be driven off after impregnation and safely disposed of.

It would be desirable to achieve improved gauge retention along with other improved blanket performance properties without the need for the use of solvents. Accordingly, there is still a need in the art for a printing blanket construction and method of manufacture which exhibits improved resistance to gauge loss.

### SUMMARY OF THE INVENTION

The present invention meets that need by providing a printing blanket and method of manufacture including at least one fabric layer which has been impregnated with a 100% solids elastomeric material comprising a polyurethane. The printing blanket resists gauge loss throughout its entire life when subjected to printing nip pressures, and also exhibits good compression set, hysteresis, and rebound properties.

According to one aspect of the present invention, a printing blanket having improved resistance to gauge loss is provided comprising a printing surface layer and at least one fabric layer, where the fabric layer has been treated to resist permanent deformation when subjected to printing nip pressures by impregnating a 100% solids elastomeric urethane compound into the fabric ply. By “resisting permanent deformation,” it is meant that the blanket retains at least 95% of its original gauge throughout the useful life of the blanket. Typically, such a useful life may include over one million impressions.

The fabric layer may comprise a woven or nonwoven fabric, a weft insertion fabric, or cord. In one embodiment, the printing blanket comprises at least two fabric plies, where each of the plies is impregnated with the elastomeric urethane compound.

The printing blanket may further include a compressible layer.

Preferably, the fabric ply or plies are treated by impregnating from about 6 to about 205 g/m² of a 100% solids elastomeric urethane compound into the fabric ply. More preferably, the fabric ply is impregnated with about 6 to about 125 g/m²of an elastomeric urethane compound. The fabric layer is impregnated with the elastomeric urethane compound such that the urethane penetrates the air spaces within individual fiber bundles in the fabric layer and fixes the fibers against relative movement. The elastomeric compound preferably comprises a cast polyurethane elastomer or a thermoplastic polyurethane.

Where the elastomeric urethane compound comprises cast polyurethane, the polyurethane is preferably applied in liquid form to the ply and then cured. Where the elastomeric compound comprises a thermoplastic polyurethane, the compound may be applied as a liquid or as a film which is heat laminated to the fabric. Because the polyurethanes are applied as 100% solids materials, the need for solvents is eliminated.

Accordingly, it is a feature of the present invention to provide a printing blanket for use in offset lithographic printing applications which resists gauge loss throughout its useful life when subjected to printing nip pressures. Other features and advantages of the invention will be apparent from the following description, the accompanying drawings, and the appended claims.

### BRIEF DESCRIPTION OF THE DRAWINGS

FIG. 1 is a perspective view of a segment of a printing blanket, with the layers partially cut away, in accordance with an embodiment of the present invention.

### DETAILED DESCRIPTION OF THE PREFERRED EMBODIMENTS

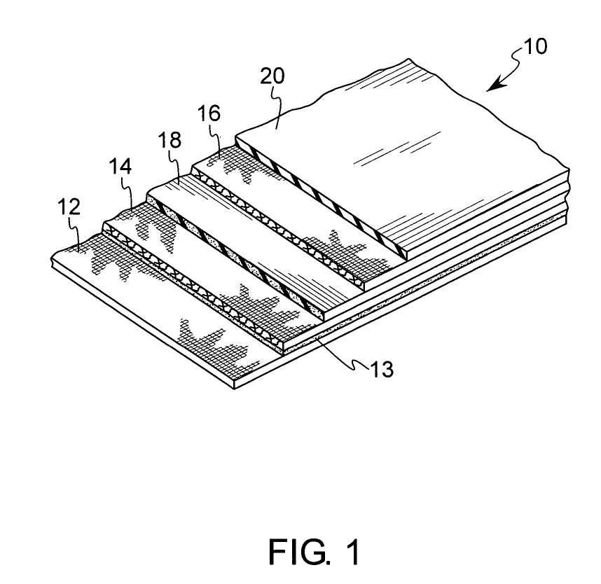

Referring now to FIG. 1, a typical printing blanket 10 in accordance with an embodiment of the present invention is illustrated. The printing blanket includes a base ply 12 comprising a fabric or polymer sheet or film, one or more reinforcing fabric plies 14 and 16, and a printing surface layer 20. The fabric plies may comprise woven fabrics, nonwoven fabrics, weft-insertion fabrics, or cord. Preferably, the fabric plies are comprised of woven fabrics. The fabric plies may be adhered together by a conventional adhesive 13 as shown.

The printing blanket may further include a compressible layer 18 formed from an elastomeric material. The compressible layer may be positioned between layers of reinforcing fabric, under printing surface layer 20, or between the printing surface layer and a fabric reinforcing layer.

Printing surface layer 20 is adapted to accept an inked image from a printing plate and may be comprised of any suitable polymeric material including natural rubbers and synthetic resins.

Preferably, each of the fabric plies 12, 14, and 16 in the blanket are impregnated with a 100% solids elastomeric urethane compound. The elastomeric compound should penetrate at least partially, if not fully, into the air spaces within individual fiber bundles in the fabric layers and fix the fibers against relative movement. Preferably, the fabric layers are impregnated with from about 6 to about 125 g/m² of the elastomeric urethane compound.

The elastomeric compound used to impregnate the fabric layers is preferably a cast elastomeric or thermoplastic polyurethane. We have found that the use of such polyurethanes provides advantages over the use of prior art rubber compounds in that the polyurethanes may be used as 100% solids materials, eliminating the need for a solvent. In addition, we have found that the use of such polyurethane compounds provide the fabric layer(s) with improved tensile strength, elongation, tear resistance and abrasion resistance over the use of prior art rubber compounds.

Where the elastomeric compound comprises cast urethane elastomer, the cast urethane is typically supplied in the form of a 100% solids material which is warmed to a liquid state and then applied to the fabric layer by dip coating, spray coating, reverse roll coating, knife coating, or slot die coating. The cast urethane elastomers are generally based on polyethers or polyesters. Depending on the specific urethane employed, the curing mechanism may comprise heat, UV, or moisture curing. Typically, heat is used to activate and/or accelerate curing. Suitable cast urethane elastomers for use in the present invention include those commercially available from Chemtura, SIKA Deutschland GmbH, and ITWC, Inc.

Where the elastomeric compound comprises thermoplastic polyurethane, such polyurethanes are typically supplied as 100% solids materials which are melted and applied as a viscous liquid to the fabric by extrusion or slot die coating, or by heated, reverse roll coating. Alternatively, the thermoplastic polyurethane may be applied to the fabric layer as a heat laminated film. The thermoplastic polyurethanes do not require curing as they regain all of their physical properties upon cooling and reformation as a solid after impregnation into the fabric. Suitable thermoplastic polyurethanes for use in the present invention include those commercially available from Huntsman Polyurethanes, Dow, and Bayer.

Whether the elastomeric compound comprises cast urethanes or thermoplastic polyurethanes, the degree of impregnation may be controlled by the selection of materials, liquid-state viscosity, and pressure. For example, dense fabric layers will allow the use of less urethane material than open fabric layers. The viscosity of the liquid-state urethane can be controlled by compounding and by application temperature. Pressure may be applied to control impregnation, for example, by the coating equipment or with the use of subsequent pressure rollers. The fabric ply is preferably maintained under tension during impregnation.

In order that the invention may be more readily understood, reference is made to the following example, which is intended to be illustrative of the invention, but not intended to be limiting in scope.

### EXAMPLE 1

Samples of single layers of reinforcing materials and a printing blanket containing two layers were tested with and without the incorporation of urethane. The printing blanket had only one layer of fabric impregnated with urethane. Table 1 below illustrates the improvement in physical properties which occurs with the incorporation of urethane.

TABLE 1

| | Load (lbs/in. of | Load (lbs/in. of |
|---|---|---|
| | width at 0.2% strain) | width at 0.2% strain) |
| Base material | (no urethane) | (with urethane) |
| Blanket | 7.7 | 20.3 |
| Woven cotton fabric | 5.9 | 34.1 |
| Polyester fabric | 8.2 | 56.3 to 109.3 |

The blanket samples were tested by simulating the printing process in which the blanket was repeatedly squeezed between two platens at high speed. Table 2 below illustrates the gauge loss after 50,000 impressions for the blanket with and without the inclusion of urethane.

TABLE 2

| | Gauge loss after | Gauge loss after |
|---|---|---|
| | 50,000 impressions | 50,000 impressions |
| Base material | (no urethane) | (with urethane) |
| Blanket | 0.058 mm | 0.033 mm |

Having described the invention in detail and by reference to preferred embodiments thereof, it will be apparent that modifications and variations are possible without departing from the scope of the invention.

What is claimed is:

1. A printing blanket having improved resistance to gauge loss comprising a printing surface layer and at least one fabric layer, wherein said at least one fabric layer has been treated to resist permanent deformation when subjected to printing nip pressures by impregnating a 100% solids elastomeric urethane compound into said fabric ply, said printing blanket retaining at least 95% of its original gauge throughout its useful life.

2. The printing blanket of claim 1 wherein said fabric layer is selected from woven fabric, nonwoven fabric, weft insertion fabric, or cord.

3. The printing blanket of claim 1 including a compressible layer.

4. The printing blanket of claim 1 wherein said at least one fabric ply has been impregnated with from about 6 to about 205 g/m² of said elastomeric urethane compound.

5. The printing blanket of claim 1 wherein said at least one fabric ply has been impregnated with from about 6 to about 125 g/m² of said elastomeric urethane compound.

6. The printing blanket of claim 1 wherein said elastomeric urethane is selected from a cast polyurethane elastomer and thermoplastic polyurethane.

7. The printing blanket of claim 1 comprising at least two fabric plies, wherein each of said fabric plies is impregnated with said elastomeric urethane compound.

8. A method of making a printing blanket having improved resistance to gauge loss comprising:
providing a printing blanket including a printing surface layer and at least one fabric layer;
impregnating said at least one fabric layer with a 100% solids elastomeric urethane compound such that said urethane penetrates into the air spaces within individual fiber bundles in said fabric layer and fixes said fibers against relative movement such that said printing blanket retains at least 95% of its original gauge throughout its useful life.

9. The method of claim 8 wherein said elastomeric urethane is selected from a cast polyurethane elastomer and thermoplastic urethane.

10. The method of claim 9 wherein said elastomeric urethane comprises a cast polyurethane elastomer and said method includes curing said polyurethane.

11. The method of claim 8 wherein said at least one fabric ply is impregnated with about 6 to about 205 g/m2 of said elastomeric urethane compound.

12. The printing blanket of claim 7 wherein said at least one fabric ply has been impregnated with from about 6 to about 125 g/m² Of said elastomeric urethane compound.
